(19) United States
(12) Patent Application Publication
(10) Pub. No.: US 2008/0152101 A1
(43) Pub. Date: Jun. 26, 2008

(54) WEB-BASED TELEPHONY SYSTEM AND METHOD

(75) Inventor: Ted Griggs, Woodside, CA (US)

Correspondence Address: SCHWEGMAN, LUNDBERG & WOESSNER, P.A., P.O. BOX 2938, MINNEAPOLIS, MN, 55402, US

(73) Assignee: Duality Inc.

(21) Appl. No.: 11/614,040

(22) Filed: Dec. 20, 2006

(51) Int. Cl. H04M 11/00

(52) U.S. Cl. 379/93.05

(57) ABSTRACT

A method and a system to establish an Internet telephone call from a terminal device. The method may comprise displaying a graphical user interface of a web telephone on the terminal device. In response to displaying the graphical user interface, a script interpreter of a web browser executing on the terminal device is activated, with the script interpreter establishing a signaling channel with a communication server, and registering the web telephone with the communication server.

### TECHNICAL FIELD

The present application relates generally to the technical field of telephony over the Internet and, in one specific example, to the provision and establishment of telephony services over the Internet, via a web browser executing on a user terminal device.

### BACKGROUND

Various alternative Voice-over-IP (VoIP) communication networks have been emerging over recent yeast to replace or enhance traditional public switched telephone networks (PSTNs). One barrier to entry for users of the alternative communication networks is the replacement of a telephone handset with either another piece of hardware that connects a user to the communication network, or through a software client. The software client typically needs to run on the user's computer to provide the user with communication connectivity through the computer's microphone and speakers.

While a software client download may be regarded as a smaller barrier to entry than a hardware device, it still is a significant commitment for a user who has to commit to the time to download, install and configure the software on their computer. Even before the installation process, the user must decide whether or not the software developer has developed a useful and secure software program. The user may also want to understand the underlying network architecture prior to installation (e.g., peer-to-peer or client-server), since certain types of networks will utilize their computer's resources differently.

Another problem that may be identified with the software client download is that the functionality of the software only exists on the computer on which the software was installed. In some cases a license fee is required for each computer on which the software is installed, which may financially restrict the accessibility of the software to the user. Even if the software has no such license fee, the functionality is still limited to the computers a user has access to and on which the software has been installed. It will further be appreciated that running the software client on multiple computers may confuse the underlying communication network, since the network may find it difficult to establish to which computer a call should be transferred. The accessibility of the software may also be limited by the user's operating system, as the software may only be compatible with a specific operating system.

### SUMMARY

A system to establish an Internet telephone call from a terminal device is provided. In an example embodiment, the system comprises a web telephone script invokable from an interface displayable by a web browser. The system may further comprise a script interpreter of the web browser, the script interpreter being under instructions of the web telephone script to display a representation of a web telephone on a graphical user interface of the terminal device. The script interpreter is further to establish a signaling channel with a communication server after the representation of the web telephone is displayed on the graphical user interface of the terminal device, in order to register the web telephone with the communication server.

In accordance with another example embodiment, there is provided a communication server to establish an Internet telephone call from a terminal device. The server may comprise a signaling protocol handler to receive a signaling request from a script interpreter of a web browser, the web browser being under instructions of a script of a web telephone embedded in a web page.

In accordance with yet another example embodiment, there is provided a method of establishing an Internet telephone call from a terminal device. The method may comprise displaying a graphical user interface of a web telephone on the terminal device. In response to displaying the graphical user interface, a script interpreter of a web browser executing on the terminal device may be activated, the script interpreter establishing a signaling channel with a communication server, and registering the web telephone with the communication server.

Another example embodiment of a method of establishing an Internet telephone call from a terminal device comprises receiving, at a communication server, a signaling channel request. The signaling channel request may be received from a script interpreter of a web browser, under instructions of a web telephone script invokable from an interface displayable by the web browser.

### BRIEF DESCRIPTION OF THE DRAWINGS

Some embodiments are illustrated by way of example and not limitation in the figures of the accompanying drawings in which:

FIG. 1 is a block diagram illustrating a system to establish an Internet telephone call from a terminal device, in accordance with an example embodiment;

FIG. 2 is a block diagram illustrating a web browser installed on the terminal device of FIG. 1, in accordance with an example embodiment;

FIG. 3 is a block diagram of a web telephone invoked by the web browser, the web browser being under instructions of a script of the web telephone for use in the system of FIG. 1, in accordance with an example embodiment;

FIG. 4 is a block diagram of a communication server for use in the system of FIG. 1, in accordance with an example embodiment;

FIG. 5 shows a high-level entity-relationship diagram illustrating tables that may be maintained within a media source or database maintained in the system of FIG. 1, in accordance with an example embodiment;

FIG. 6 is a flow diagram of a method to establish an Internet telephone call from a terminal device, showing the interaction between a web server, web browser, communication server, gateway and other terminal devices, in accordance with an example embodiment;

FIG. 7 is a flow diagram of a method to establish an Internet telephone call to a terminal device, showing the interaction between a web server, web browser, communication server, gateway and originating terminal device, in accordance with an example embodiment;

FIG. 8 is a flow diagram of a method to terminate the Internet telephone calls of FIG. 6 and FIG. 7, in accordance with an example embodiment;

FIG. 9 is a representation of an example graphical user interface of a web telephone in accordance with an example embodiment;

FIG. 10 is a representation of an example graphical user interface of a simplified web telephone in accordance with another example embodiment; and

FIG. 11 is a block diagram showing a machine for performing any one of the example methods described herein.

### DETAILED DESCRIPTION

Example methods and systems to establish an Internet telephone call from a terminal device are described. In the following description, for purposes of explanation, numerous specific details are set forth in order to provide a thorough understanding of example embodiments. It will be evident, however, to one skilled in the art that the present invention may be practiced without these specific details.

### Architecture

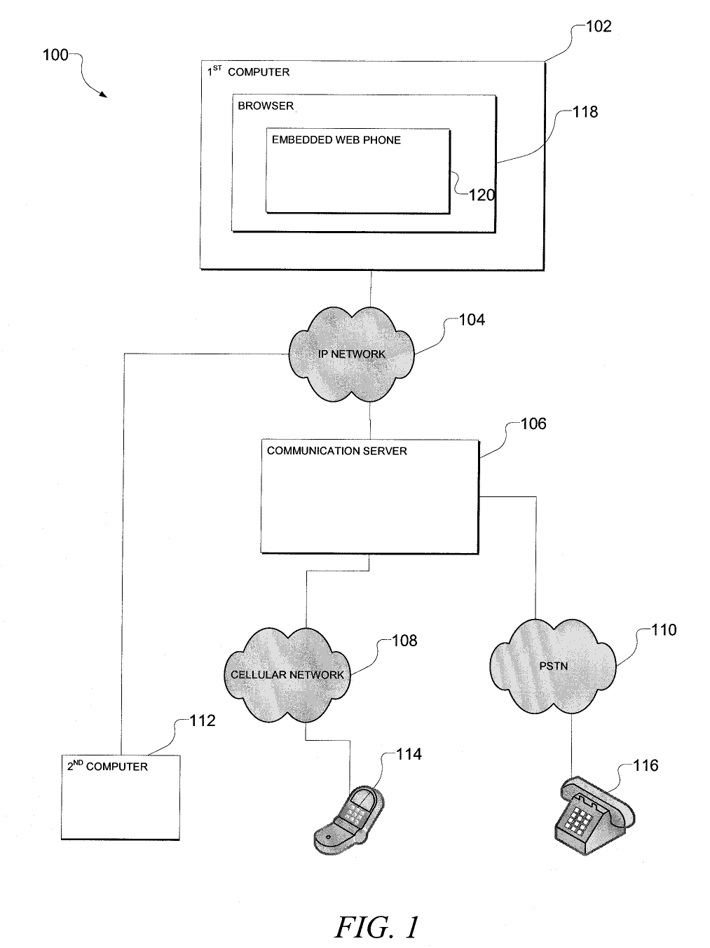

Referring to FIG. 1, reference numeral 100 generally indicates a system and network, in accordance with an example embodiment, to establish an Internet telephone call from a terminal device, shown as a first computer 102. The terminal device or first computer 102 is communicatively connected to an Internet Protocol (IP) network 104, such as a local area network (LAN), a wide area network (WAN), an intranet or the Internet. The IP network 104 is in turn connected to a communication server 106 which is configured to switch telephone calls between the IP network 104, a cellular network 108 and a Public Switched Telephone Network (PSTN) 110.

The IP network 104 connects the first computer 102 to other terminating devices, e.g., a second computer 112. The first computer 102 may, when making a call, function as an originating IP network device while the second computer 112 may function as a terminating IP network device, thereby forming a Voice over IP (VoIP) network. Likewise, the first computer 102 may, when receiving a call from the second computer 112, function as a terminating IP network device while the second computer 112 may function as an originating IP network device.

It will be appreciated that the first and second computers 102 and 112 may be connected via network links that may either be an IP trunk or an IP call-line.

As shown in FIG. 1, the first computer 102 may also be connected to a mobile device or handset 114 via the communication server 106 and a cellular network 110. Similarly, the first computer 102 may connect to telephones, e.g., telephone 116, connected to a Public Switched Telephone Network (PSTN) 110. The communication server 106 is accordingly configured to migrate a number of end customers, e.g., first computer 102, second computer 112, mobile device 114 and telephone 16 between time-division multiplexing (TDM) based voice service to call agent-based packet voice services or vice versa, depending on the configuration of the system.

It will be appreciated that various VoIP protocols may be used between the first computer 102, the IP network 104, the communication server 106 and the second computer 112, with the choice of VoIP protocols depending on the services that need to be delivered over the network 10. For example, between the first and second computers 102 and 112 and the communication server 106 the following VoIP protocols may be used: H.323, TCP/IP, MGCP, and Signal Initiation Protocol (SIP).

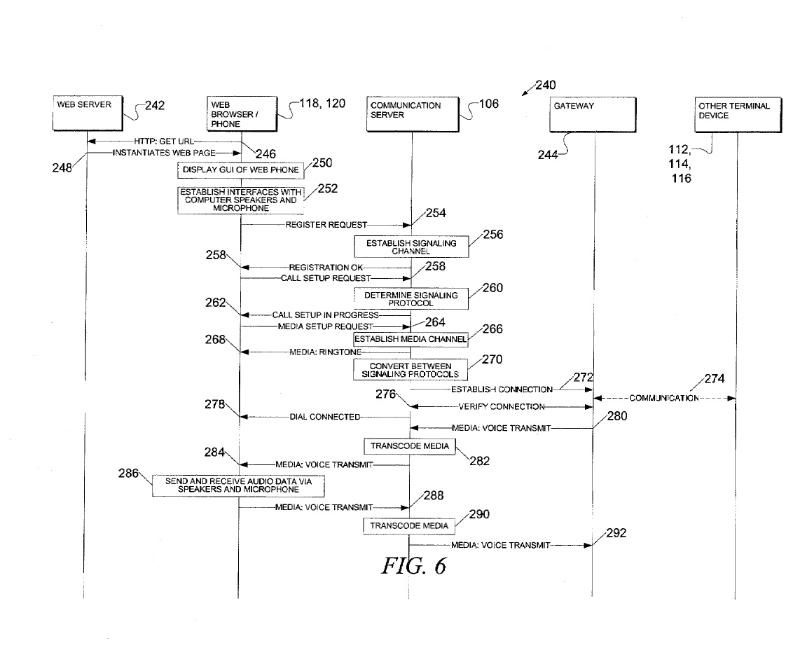

In an example embodiment, the first computer 102 may have a web browser 118 installed on it. The web browser 118 is a software application used to access a web page of a website maintained on a web server (shown in FIGS. 6 to 8 by reference 242). Well known web browsers include Microsoft Internet Explorer, Mozilla Firefox, Apple Safari and Netscape. The web browser 118 may execute a web telephone script invokable from an interface displayable by the web browser 118. The web telephone script of the web page implements an embedded web phone 120 used to establish Internet telephone calls to the second computer 112, mobile handset 114 and telephone 116. Alternatively, the web telephone script may comprise a reference such as a hyperlink, e.g., a Uniform Resource Locator (URL) that may be used by the web browser 118 to execute the web telephone script as if it was embedded in the web page.

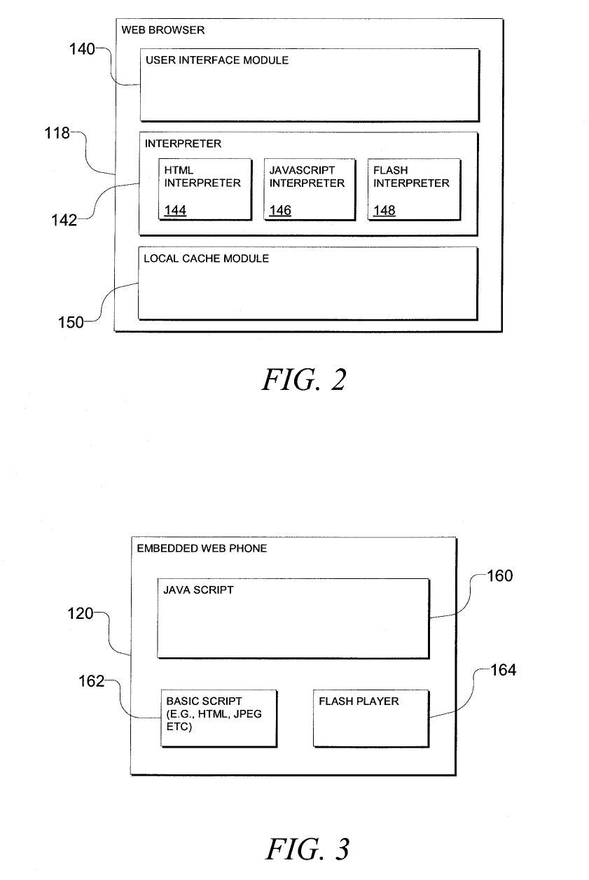

Turning to FIG. 2, a block diagram to illustrate an example embodiment of the web browser 118 is shown. The web browser 118 comprises a user interface module 140 which is configured to present a user with a graphical user interface of the web browser 118 on the terminal device or first computer 102. By accessing the graphical user interface of the web browser 118, a user may navigate to a particular web page of a website that may be hosted on a web server. For example, a user may enter a Uniform Resource Locator (URL) into a field, in response to which the web browser 118 will navigate to the website's domain.

In order to make web pages accessible and to present a web page to a user as a graphical user interface, the web browser 118 may further include an interpreter 142. Web pages are usually in a hyper-text markup language (HTML) file format, but may further include other formats (e.g., JPEG, PNG and GIF image formats), scripts such as applets (e.g., Java Applets for interactive functionality) or other plugins, (e.g., plugins that play Flash presentations). In one example embodiment, the interpreter 142 may include a HTML interpreter 144, a JavaScript interpreter 146 and a Flash interpreter 148 to enable the web browser 118 to present web pages to a user. From the above, it should however be appreciated that the interpreter 142 may include additional interpreters.

The web browser 118 may further include a local cache module 150 which may assist the interpreter 142 in displaying various web pages accessed by the web browser 118. In one example embodiment, the local cache module 150 stores a web page as downloaded from a web server to be interpreted by the script interpreter 142.

FIG. 3 shows a block diagram of a web telephone invoked by the web browser of FIG. 2, in accordance with an example embodiment. The web telephone comprises a web telephone script which is invokable from an interface displayable by the web browser 118. For example, the web telephone script may include basic script 162, together with JavaScript 160 that may in be in the form of applets and Flash presentations that may be embedded in web page. Alternatively, and as mentioned, the web page may comprise a reference such as a hyperlink, e.g., a Uniform Resource Locator (URL) to a web telephone script. This enables the web browser 118 to execute the web telephone script as if it was embedded in the web page.

The script interpreter 142 of the web browser 118 is under instructions of the scripts to perform certain web telephone functionalities. The web telephone scripts include instructions for the script interpreters to display a representation of a web telephone on a graphical user interface (e.g., a screen) of the terminal device 102. The scripts also include instructions to establish a signaling channel with the communication server 106 of FIG. 1 after the representation of the web telephone has been displayed on the graphical user interface of the first computer 102. As is described in more detail below, the signaling channel is established in order to register the web telephone 120 with the communication server 106.

The web telephone script also instructs the script interpreters 142 of the web browser 118 to interface the web telephone script with a microphone and a speaker of the terminal device 102. This enables communication to take place between a user of the terminal device 102 and other telephony terminal devices 112, 114 or 116. Whenever a call is to be established with another terminating device, e.g., the second computer 114, mobile handset 116 and telephone 118, the script interpreter 142 is to receive a call request entered by the user via the graphical user interface of the web telephone 120. The script interpreter 142 is then to transmit the call request to the communication server 106. After transmitting the call request to the communication server 106, the script interpreter, still under instructions from the web telephone script, is to establish a media channel with the communication server 106.

In order for the user to hear a ring-tone when a call is made, the script interpreter 142 is to receive a ring-tone from the communication server 106, prior to the communication server 106 making a connection with another terminating device, e.g., telephone 118, associated with the dialed number.

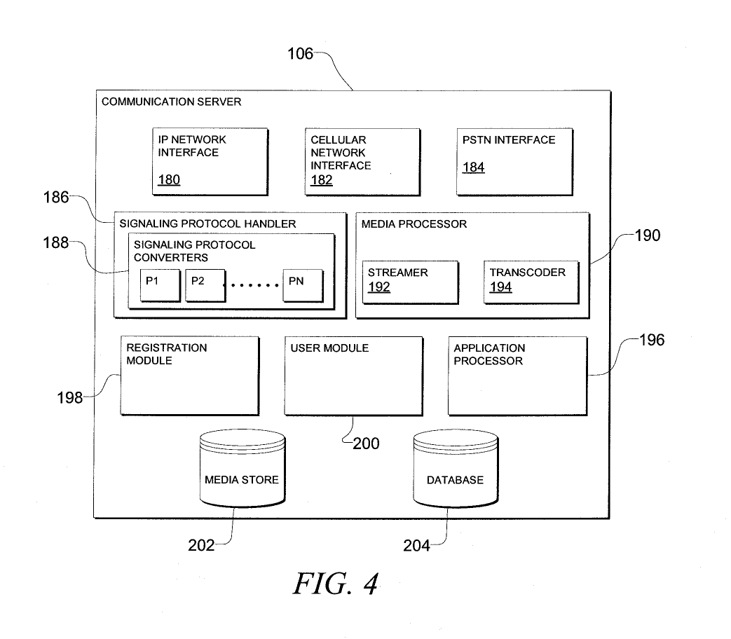

Turning to FIG. 4, a block diagram of the communication server 106 of FIG. 1, in accordance with an example embodiment is shown. The communication server 106 includes interfaces, e.g., an IP network interface 180, a cellular network interface 182 and a PSTN interface 184. The IP network interface 180 connects the communication server 106 with the IP network 104. Similarly, the cellular network interface 182 connects the communication server 106 with the cellular network 110, while the PSTN interface 184 connects the communication server 106 with the PSTN 114. Each interface 180 to 184 is configured to communicate with the respective networks using the relevant protocols.

The communication server 106 may further comprise a signaling protocol handler 186 which comprises signaling protocol converters 188, indicated by references P1, P2 . . . PN. The signaling protocol handler 186 is to receive a signaling request from the script interpreter 142 of the web browser 118. As mentioned, the web browser 118 would be under instructions of the scripts of the web telephone invoked by a web page. The signaling protocol handler 186 is to establish the signaling channel, in response to receiving the signaling channel request. Once the signaling channel has been established and a user wants to make a call to any other terminal device 112, 114 or 116, the user enters a telephone number via the graphical user interface of the web telephone. This results in a call request being transmitted to and being received by the signaling protocol handler 186. From the call request, an application processor 196 of the communication server 106 may determine whether the web telephone 120 that originated the signaling channel request is valid and, if so, the call routing that may be necessary to establish a connection with the other terminal device, e.g., the second computer having an IP telephone 112, the mobile handset 114 or the telephone 116 identified by the call request. For example, in one embodiment, the application processor 196 may perform a table lookup in a database to determine whether the web telephone 120 that originated the signaling channel request is valid. Further, for example, in one embodiment the application processor 196 may identify a route to the other terminal device or a gateway that may be used to connect to the other terminal device.

The signaling protocol handler 186 is also to determine, based on the received call request, a signaling protocol to establish a connection with a telephone, e.g., the second computer having an IP telephone 112, the mobile handset 114 or the telephone 116 identified by the call request. Once the signaling protocol has been established, the relevant signaling protocol converter 188 is enabled to convert between the different signaling protocols used in different parts of the network. The signaling protocol handler 186 is also to transmit a call request to a gateway (shown by reference numeral 244 in FIGS. 6 to 8) using the determined signaling protocol, thereby to establish a telephone call between the web telephone 120 and any other telephone in the network.

In an example embodiment, the communication server 106 may also include a media processor 190 comprising a media streamer 192 and transcoder 194. The media processor 190 is to establish a media channel with the script interpreter 142 of the web telephone 120. This media channel is to be established in response to the signaling protocol handler 186 receiving a call request. Prior to establishing a call, the media processor 190 is to transmit a ring-tone to the web telephone 120. This ring-tone may be stored in a media store 202, e.g., a disk containing media, which also forms part of the communication server 106.

The media transcoder 194 is configured to convert one media format to another media format. The format of the media to be transmitted may be dependent on the protocol of the underlying networks in which the terminal devices operate. For example, in the event that H.323 is the protocol used for the communication from the second computer 112, the media transcoder 194 may need to convert the media format to another media format, such as SIP or TCP/IP, or vice versa. This is described in more detail below.

The communication server 106 may also comprise a registration module 198 that manages the registration process of new users of the web based telephony system to the communication server. The registration module receives new user data which is stored in a database 204. This user data enables the communication server 106 to maintain records of all registered users and further enables a user module 200 of the communication server 106 to identify and verify users whenever a web telephone is invoked. This is necessary for the communication server 106 to be able to designate telephone numbers to invoked web telephones and to transmit any call requests received from other terminal devices to the relevant web telephone, should the web telephone be registered.

As every computer has an installed web browser employing protocols operational across most operating systems, the ability to embed a web telephone in a web page executed by a browser or to reference a web telephone from a web page without the need for a user to download any software eliminates a barrier to entry for an alternative communication network that utilizes such software.

### Data Structures

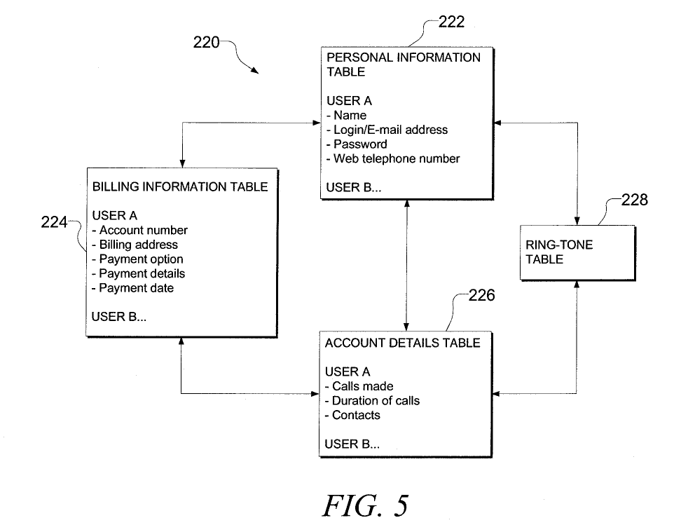

FIG. 5 is a high-level entity-relationship diagram, illustrating various tables 220 that may be maintained within the media store 202 and database 204, and that are utilized by and support the communication server 106. Information is stored for each user of the web telephony system. For example, prior to the first use of the web telephone 120, a user has to register with the communication server 106. This registration process would typically be an online process, during which the user is requested to provide certain personal information and billing information. Every time the user accesses the web telephone after the first registration, the user may use a designated or selected login name and password to register the web telephone 120 with the communication server 106. This enables the communication server 106 to know that call requests received from other terminal devices may be forwarded to the web telephone 120.

Billing information is also captured during the first registration process and is maintained in the billing table 224. This information may include the user's account number, billing address, payment option (e.g., whether the user pays by credit card, PayPal or debit order), payment details and a monthly payment date.

An account details table 226 may contain information on the calls the user has made, as well as the duration of the calls and costs associated with each call.

A ring-tone table 228 may also be maintained in the media store 202, the ring-tone table 228 containing different ring-tones or even advertisements. The different ring-tones and advertisements may be played to a user of a terminal device 102 while a call is being established with another terminal device 112, 114 or 116.

### Flowcharts

FIG. 6 shows a flow diagram of an example method 240 to establish an Internet telephone call from a terminal device 102. In one example embodiment, the method may be implemented by the system of FIG. 1. FIG. 6 shows the operations of the method divided between operations executed or performed by the a web server 242, web browser 102, communication server 106, a gateway 244 and other terminal devices, e.g. the second computer 112, mobile handset 114 and telephone 116.

As shown by reference numeral 246, a user uses a web browser 118 installed on a terminal device (e.g., first computer 102) to access a web page that is maintained on the web server 242. By accessing the web page, the web page is downloaded to the first computer (see reference 248) and the web browser 118 displays a graphical user interface of a web telephone 120 on a display of the terminal device 102 (see block 250). The web telephone 120 is displayed after a script interpreter 142 of the web browser 118 executing on the terminal device 102 has interpreted various scripts that form the web page.

In one example embodiment, once the graphical user interface of the web telephone has been displayed, the script interpreter 142 of the web browser 118 interfaces the web telephone script with a microphone and a speaker of the terminal device 102 (see block 252). As indicated by references 254 to 258, in response to displaying the graphical user interface, the script interpreter 142 establishes a signaling channel with the communication server 106 and registers the web telephone 120 with the communication server 106. The registration process may include a login and password being entered via the graphical user interface of the web telephone 120. The login and password may then be transmitted to the communication server 106 for identification and validation by the user module 200. Once the web telephone 120 has been identified and validated by the user module 200, the communication server 106 establishes the location of the web telephone 120 in the network, in order to forward any call requests received from other originating terminal devices to the terminal device 102 associated with the web telephone 120.

In an example embodiment, the web browser 118 receives a call request, which is entered by a user via the graphical user interface of the web telephone 120. This call request is transmitted through the script interpreter 142 to the communication server 106 (see reference 258). As shown by block 260, a signaling protocol handler of the communication server 106 determines, in response to the received call request, a signaling protocol to establish a connection with a telephone identified by the call request. Reference 262 shows an intermediate communication to inform the web telephone 120 that the call request is in progress, whereafter the web telephone, through the script interpreter 142 invoked by the web telephone scripts, establishes a media channel with the script interpreter 142 (see references 264 and 266).

The communications between the web browser 118 executing the web telephone 120 and the communication serverIO6 may typically be in a proprietary protocol of the browser 118 and communication server 106. In one example embodiment the proprietary protocol may be TCP/IP.

In an example embodiment, the application processor 196 of the communication server 106 may access the media store 202 and may select an appropriate ring-tone to be transmitted to the web telephone 120 executed on the web browser 118. Once this selection has been made, the ring-tone is transmitted from the communication server 106 to the web telephone 120 (see reference 268), where the ring-tone is played to the user of the terminal device 102. This indicates to the user that a call is in the process of being established.

The signaling protocol handler 186 and its converters 188 now converts the call request between the different signaling protocols, in order for the call request to be transmitted to a gateway 244 (see block 270).

References 272 to 276 indicate how a call is established to another terminal device, which may be the second computer 112, the mobile handset 114 or the telephone 116. The communication server 106 communicates through the gateway 244 to the other terminal devices 112, 114 and 116 and transmits a call request to the gateway 244 using the determined signaling protocol.

The transmissions to the gateway 244 may be in accordance with Signal Initiation Protocol (SIP). For example, the communication server 106 may transmit an SIP invite to the gateway 244, and may in turn receive an SIP progress message, prior to receiving a SIP answer. The voice media may be transmitted from the gateway 244 as Real-time Protocol (RTP). From the above it will be apparent that the communication server 106 acts as a proxy for the web phone 120, with the communication between the web browser 118 executing the web phone 120 and the communication server 106 being in accordance with a proprietary protocol, while the communication between the communication server 106 and the gateway 244 is in accordance with well-known VoIP standards.

Reference 278 indicates that the communication server 106 transmits to the web browser 118 executing the web telephone 120 a message to indicate that the user of the other terminating device is available. Voice media is now transmitted from the other terminating device 112, 114 or 116 via the gateway 244 to the communication server 106 (see reference 280). The transcoder 194 of the media processor 190 transcodes the media stream between the various protocols (e.g., from RTP to TCP/IP) (see block 282) and sends this transmission through to the web browser 118 executing the web telephone scripts (see reference 284). As indicated by block 286, the script interpreter 142 receives the audio data and plays it via the speakers to the user.

References 288 to 292 indicate the user talking into the microphone of the terminal device 102. The script interpreters 142 of the web browser 118 receives this transmission, transmits it via the established media channel to the communication server 106, which transcodes the media and transmits it on to the gateway 244.

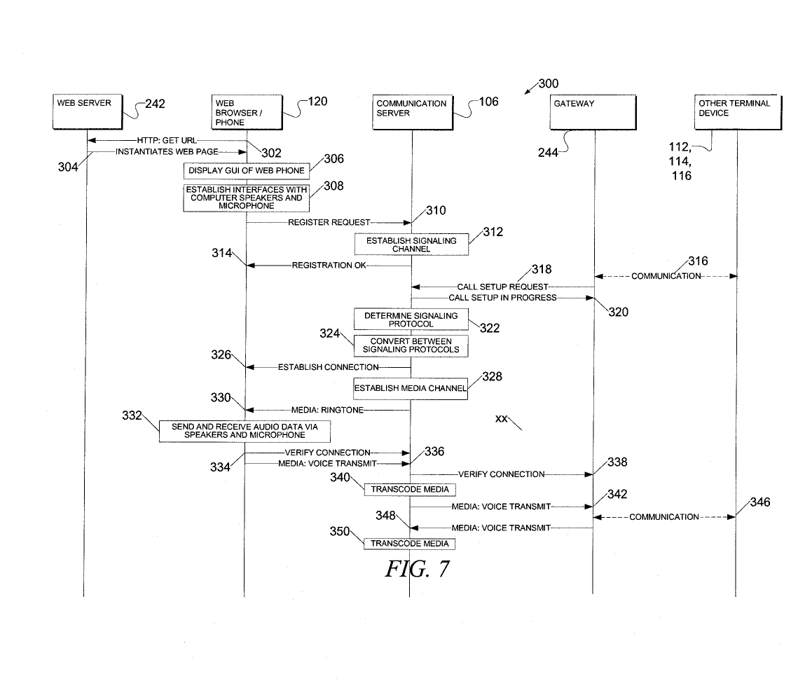

FIG. 7 shows a flow diagram of an example method 300 to establish an Internet telephone call to a terminal device 102 in accordance with an example embodiment. In one example embodiment, the method may be implemented by the system of FIG. 1. Similar to FIG. 6, the operations of the method are divided between operations executed or performed by the a web server 242, web browser 102, communication server 106, a gateway 244 and other terminal devices, e.g., the second computer 112, mobile handset 114 and telephone 116.

The initial operations of this method are the same as the initial operations described according to FIG. 6. As shown by reference numeral 302, a user uses a web browser 118 installed on a terminal device to access a web page that is maintained on the web server 242. The web page is downloaded to the first computer (see reference 304) and the web browser 118 displays a graphical user interface of a web telephone 120 on the terminal device 102 (see block 306). As described above, the web telephone 120 is displayed after a script interpreter 142 of the web browser 118 executing on the terminal device 102 has interpreted various scripts that form the web page.

Once the graphical user interface of the web telephone 120 has been displayed, the script interpreter 142 of the web browser 118 may interface the web telephone script with a microphone and a speaker of the terminal device 102 (see block 308). As indicated by references 310 to 314, in response to displaying the graphical user interface, the script interpreter 142 establishes a signaling channel with the communication server 106 and registers the web telephone 120 with the communication server 106.

Reference 316 indicates a communication originating from another terminating device 112, 114 or 116, and that a call setup request is transmitted from the gateway 244 to the communication server 106 (see reference 318). The communication server 106 confirms that the call setup is in progress (reference 320). In an example embodiment, the call setup request includes the web telephone number of the web telephone executed through the web browser 118.

Similar to the communications of FIG. 6, the communications between the other terminal device 112, 114 or 116, the gateway 244 and the communication server 106 may be in accordance with standard VoIP communications, e.g., SIP and RTP.

As shown by block 322, a signaling protocol handler of the communication server 106 determines, in response to the received call request, a signaling protocol to establish a connection between the other terminating device and the web telephone 220. The signaling protocol handler 186 and its converters 188 now converts the call request between the different signaling protocols, in order for the call request to be transmitted to the web telephone 120 (see block 324).

References 326 and 328 show that a connection is established with the web browser 118 executing the web telephone scripts and also the establishment of a media channel between the communication server 106 and the script interpreters of the web browser 118.

In an example embodiment, the application processor 196 of the communication server 106 may access the media store 202 and may select an appropriate ring-tone to be transmitted to the web telephone 120 executed on the web browser 118. Once this selection has been made, the ring-tone is transmitted from the communication server 106 to the web telephone 120 (see reference 330), where the ring-tone is played to the user of the terminal device 102. This indicates an incoming call from another terminal device to the user.

References 332 to 350 are similar to the transmissions described according to FIG. 6 and indicate the transmission of audio data from the web telephone 120 to the communication server 106, where it may be transcoded to another protocol for further transmission to the gateway 244 and the other terminal device.

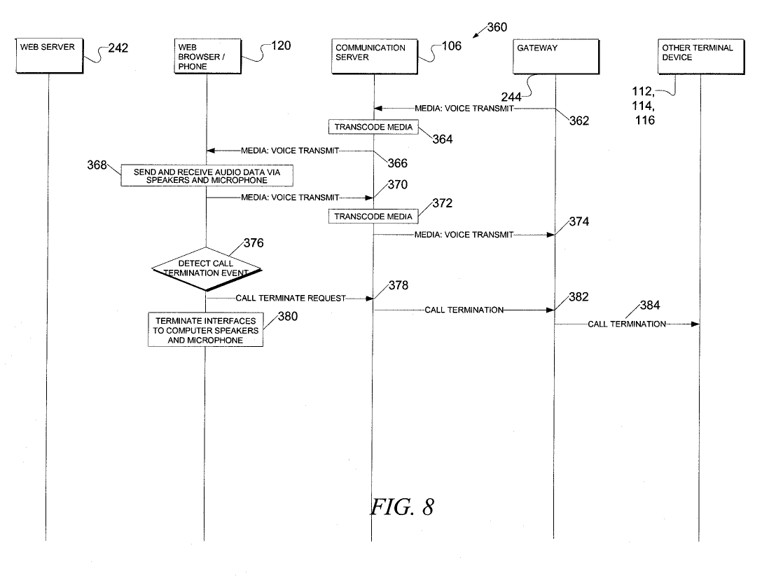

FIG. 8 is a flow diagram of a method 360 to terminate the Internet telephone calls of FIG. 6 and FIG. 7, in accordance with an example embodiment. In one example embodiment, the method may also be implemented by the system of FIG. 1.

The first references 362 to 374 show communication transmissions between the web telephone 120 implemented through scripts executed by the web browser 118 and another terminating device 112, 114 and 116.

As shown by decision 376, the script interpreter 142 of the web browser 118 detects a call termination event. This event may be executed by the user selecting a “hang up” soft key on a graphical user interface displayed by the web browser 118 on a display of the terminal device 102. The web browser 118 now executes a web telephone script and transmits a call termination request to the communication server 106 (see reference 278). The communication server 106 transmits this request to the gateway 244 and the other terminal device in order to indicate that the user of the first computer 102 is terminating the call (see references 382 and 384). Simultaneously another script invoked by the web browser 118 terminates the interfaces to the terminal device's speaker and microphone, thereby terminating the call at the first computer 102.

### User Interfaces

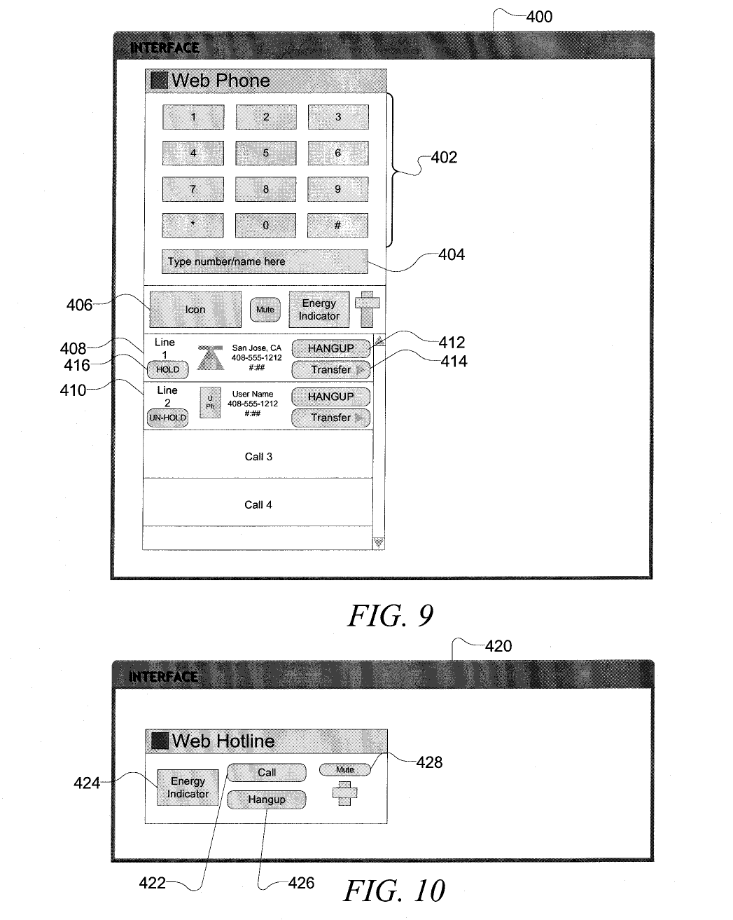

FIG. 9 shows a representation of an example graphical user interface 400 of a web telephone in accordance with an example embodiment. The graphical user interface 400 of the web telephone 120 comprises a soft keypad 402 which may be used by a user to input a telephone number into an input area 404. The graphical user interface 400 further includes a display panel 406 which has various indicators, e.g., to show whether the call has been muted, and to show the sound quality of the microphone.

The graphical user interface may further include call displays indicated by reference numerals 408 and 410. Each call display shows whether a call is active, the caller's name (if available) and the caller's telephone number (if caller identity is activated). Each call display also provides functionality to terminate the call (by pressing the “HANGUP” soft-key 412) or to transfer the call (by pressing the “Transfer” soft-key 414). Alternatively, the user can “hold” or “un-hold” the call by pressing the “Hold” soft key 416.

FIG. 10 shows a representation of another example graphical user interface 420 of a simplified web telephone in accordance with another example embodiment. This simplified web telephone may be embedded on any website to enable a user to contact a particular third party, e.g., customer care or a helpline. The user would accordingly not be able to enter a telephone number to call, but would activate a “Call” soft-key 422. By activating the “Call” soft-key 422 the user would immediately execute a telephone call to the predefined number. The graphical user interface 420 may also include an energy indicator 424, a “HANGUP” soft-key 426 and a “MUTE” soft-key 428.

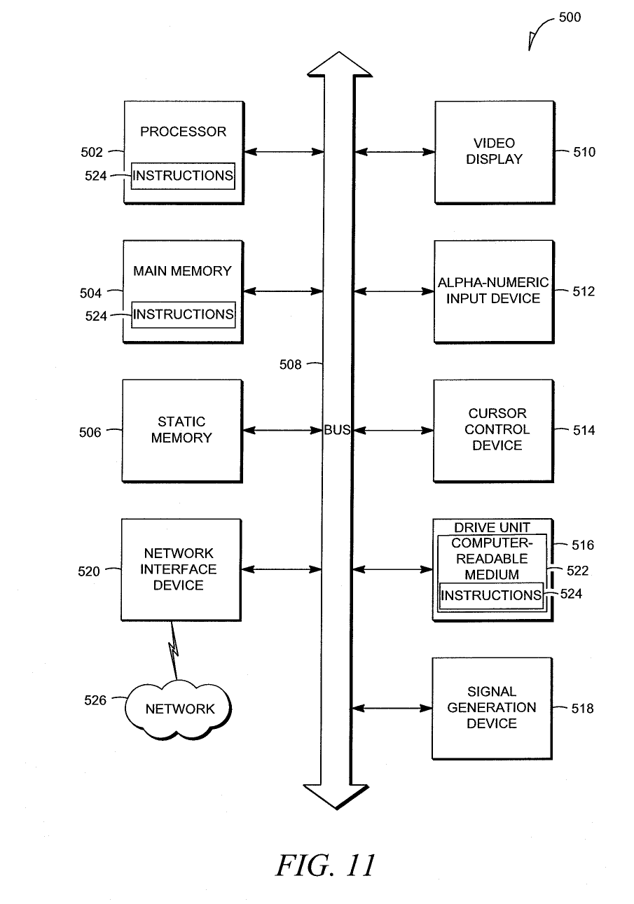

FIG. 11 shows a diagrammatic representation of machine in the example form of a computer system 500 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU) a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a cursor control device 514 (e.g., a mouse), a disk drive unit 516, a signal generation device 518 (e.g., a speaker) and a network interface device 520.

The disk drive unit 516 includes a machine-readable medium 522 on which is stored one or more sets of instructions (e.g., software 524) embodying any one or more of the methodologies or functions described herein. The software 524 may also reside, completely or at least partially, within the main memory 504 and/or within the processor 502 during execution thereof by the computer system 500, the main memory 504 and the processor 502 also constituting machine-readable media.

The software 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to establish an Internet telephone call from a terminal device have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system to establish an Internet telephone call from a terminal device, the system comprising:
a web telephone script invokable from an interface displayable by a web browser, and
a script interpreter of the web browser, the script interpreter being under instructions of the web telephone script to:
display a representation of a web telephone on a graphical user interface of the terminal device; and
establish a signaling channel with a communication server after the representation of the web telephone is displayed on the graphical user interface of the terminal device, in order to register the web telephone with the communication server.

2. The system of claim 1, wherein the script interpreter is to interface the web telephone script with a microphone and a speaker of the terminal device.

3. The system of claim 2, wherein the script interpreter is to receive a call request entered via the graphical user interface and wherein the script interpreter is to transmit the call request to the communication server.

4. The system of claim 3, wherein the script interpreter is to establish, after transmitting the call request to the communication server, a media channel with the communication server.

5. The system of claim 4, wherein the script interpreter is to receive a ring-tone from the communication server, prior to the communication server making a connection with a telephone associated with the dialed number.

6. A communication server to establish an Internet telephone call from a terminal device, the server comprising a signaling protocol handler to receive a signaling request from a script interpreter of a web browser, the web browser being under instructions of a script of a web telephone.

7. The communication server of claim 6, wherein the script of the web telephone is reference via a hyperlink to the web page or embedded in a web page.

8. The communication server of claim 7, wherein the signaling protocol handler is to establish the signaling channel, in response to receiving the signaling channel request.

9. The communication server of claim 8, wherein the signaling protocol handler is to receive a call request from the web telephone, the call request being entered via a graphical user interface of the web telephone.

10. The communication server of claim 9, further comprising a media processor to establish a media channel with the script interpreter of the web telephone, in response to the signaling protocol handler receiving the call request.

11. The communication server of claim 10, wherein the media processor is to transmit a ring-tone to the web telephone.

12. The communication server of claim 11, wherein the signaling protocol handler is to determine, based on the received call request, a signaling protocol to establish a connection with a telephone identified by the call request.

13. The communication server of claim 12, wherein the signaling protocol handler is to transmit a call request to a gateway using the determined signaling protocol, thereby to establish a telephone call between the web telephone and the telephone.

14. A method of establishing an Internet telephone call from a terminal device, the method comprising:
displaying a graphical user interface of a web telephone on the terminal device; and
in response to displaying the graphical user interface, activating a script interpreter of a web browser executing on the terminal device;
the script interpreter establishing a signaling channel with a communication server, and registering the web telephone with the communication server.

15. The method of claim 14, further comprising receiving a call request via the graphical user interface and transmitting the call request to the communication server.

16. The method of claim 15, further comprising the script interpreter establishing, in response to transmitting the call request to the communication server, a media channel with the communication server.

17. The method of claim 16, further comprising receiving a ring-tone from the communication server, prior to a connection being made with a telephone associated with the dialed number.

18. A method of establishing an Internet telephone call from a terminal device, the method comprising:
receiving, at a communication server, a signaling channel request, the signaling channel request being received from a script interpreter of a web browser, under instructions of a web telephone script invokable from an interface displayable by the web browser.

19. The method of claim 18, further comprising establishing the signaling channel, in response to receiving the signaling channel request.

20. The method of claim 19, further comprising receiving a call request via a graphical user interface and establishing a media channel with the script interpreter, in response to receiving the call request.

21. The method of claim 20, further comprising transmitting a ring-tone from the communication server to the web telephone.

22. The method of claim 21, further comprising determining, at a signaling protocol handler and in response to the received call request, a signaling protocol to establish a connection with a telephone identified by the call request.

23. The method of claim 22, further comprising transmitting a call request to a gateway using the determined signaling protocol, in order to establish a telephone call between the web telephone and the telephone identified by the call request.

24. A communication server to establish an Internet telephone call from a terminal device, the server comprising first means for receiving a signaling request from a script interpreter of a web browser, the web browser being under instructions of a script of a web telephone.

25. The communication server of claim 24, wherein the first means is to establish the signaling channel, in response to receiving the signaling channel request.

26. The communication server of claim 25, wherein the first means is to receive a call request from the web telephone, the call request being entered via a graphical user interface of the web telephone.

27. The communication server of claim 26, further comprising second means for establishing a media channel with the script interpreter of the web telephone, in response to the first means receiving the call request.

28. A machine-readable medium embodying a set of instructions to perform the method of claim 14.

29. A machine-readable medium embodying a set of instructions to perform the method of claim 18.
